(19) United States
(12) Patent Application Publication
(10) Pub. No.: US 2026/0149221 A1
(43) Pub. Date: May 28, 2026

(54) Electrical Connector and Electrical Connector Assembly

(71) Applicants: Tyco Electronics (Shanghai) Co., Ltd., Shanghai (CN); Tyco Electronics Technology (SIP) Co., Ltd., Suzhou (CN)

(72) Inventors: Huan Chen, Suzhou (CN); Shiyang (Sean) Tan, Wuhan (CN); Jianxiong (Jesse) Li, Shanghai (CN); Zhaowen Zhou, Shanghai (CN); Shuai (Ted) Yuan, Shanghai (CN)

(73) Assignees: Tyco Electronics (Shanghai) Co., Ltd., Shanghai (CN); Tyco Electronics Technology (SIP) Co., Ltd., Suzhou (CN)

(21) Appl. No.: 19/400,320

(22) Filed: Nov. 25, 2025

(30) Foreign Application Priority Data
Nov. 27, 2024 (CN) 202411713503.3

(51) Int. Cl. H01R 13/52; H01R 13/504; H01R 13/533; H01R 13/627; H01R 13/639

(52) U.S. Cl. CPC H01R 13/521; H01R 13/504; H01R 13/533; H01R 13/6277; H01R 13/639; H01R 2201/26

(57) ABSTRACT

An electrical connector includes a conductive terminal, an insulated terminal housing, a die-cast housing, a first sealing component and a second sealing component. The insulated terminal housing is at least partially accommodating the terminal. The die-cast housing is at least partially accommodating the terminal housing. The first sealing component is sleeved onto the terminal. The terminal is adapted to be axially inserted into the terminal housing in response to the first sealing component being sleeved onto the terminal, with the first sealing component being pressed against and sealed between the terminal and the terminal housing. The second sealing component is sleeved onto the terminal housing. The terminal housing is adapted to be inserted into the die-cast housing in response to the second sealing member being sleeved onto the terminal housing, with the second sealing component being pressed against and sealed between the terminal housing and the die-cast housing.

### CROSS-REFERENCE TO RELATED APPLICATION

This application claims the benefit of Chinese Patent Application No. CN 202411713503.3 filed on Nov. 27, 2024 in the State Intellectual Property Office of China, the whole disclosure of which is incorporated herein by reference.

### FIELD OF THE DISCLOSURE

The disclosure relates to the field of electrical connectors, and more particularly, to an electrical connector and an electrical connector assembly.

### BACKGROUND OF THE INVENTION

An electrical connector assembly is an electronic component for transmission and exchange of electric current or signals between or among electronic system apparatuses. Functioning as a node, independently or together with cables, the electrical connector assembly transmits electric current or signals between or among devices, assemblies, apparatus, and systems, and maintains that no change (such as signal distortion, energy loss) may occur between various systems, thus the electrical connector assembly is a fundamental element necessary for constituting the connections of an entire complete system. For example, I/O modules are typically used for connections between switches, and between a switch and a server.

In the related art, particularly concerning an application of electrical connectors in the field of transmission inverters, a main structure of conventional electrical connector assemblies is usually in the form of an electrical connector (and its assembly structure) in a 90-degree bending lead-out way or in a 180-degree straight lead-out way. On one hand, in the related art, electrical connector products in a 90-degree bending lead-out way or in a 180-degree straight lead-out way, when used in high-voltage inverter circuits to cooperate with environments for example ATF oil (i.e. automatic transmission fluid), typically need to withstand conditions such as high voltage and/or high current (and the resulting high operating temperatures), high vibration, and the need for self-sealing, and the like; and furthermore, such application scenarios have extremely stringent performance requirements for product performance. On the other hand, in the related art, electrical connector products in a 90-degree bending lead-out way or in a 180-degree straight lead-out way, which are used currently on the market for low-voltage scenarios, usually do not possess excellent self-sealing performance for the application environment of transmission inverters, tending to lead to ATF leakage. Furthermore, similar electrical connector designs typically employ a potting composite material to implement sealing, rather than employing an integrated or monolithic sealing structure design, thus resulting in drawbacks such as high cost and degradation of performance.

Therefore, in the related art, there is an urgent need for an improved 90-degree electrical connector and assembly thereof, which is realized by improvements in the assembly structure, for example, an integrally coaxial radial filling self-sealing design based on a modular combination structure achievable with existing processes, which is adapted for application in high voltage environment and meets test requirements such as high vibration and high current, and is also adapted for application in inverter application scenarios of high-voltage circuits with ATF oil. Moreover, the modular design of the structure also facilitates cost reduction, and thus can also broaden the application fields of electrical connector products in the market.

### SUMMARY OF THE INVENTION

According to an embodiment of the present disclosure, an electrical connector includes a conductive terminal, an insulated terminal housing, a die-cast housing, a first sealing component and a second sealing component. The insulated terminal housing is at least partially accommodating the terminal. The die-cast housing is at least partially accommodating the terminal housing. The first sealing component is sleeved onto the terminal. The terminal is adapted to be axially inserted into the terminal housing in response to the first sealing component being sleeved onto the terminal, with the first sealing component being pressed against and sealed between the terminal and the terminal housing. The second sealing component is sleeved onto the terminal housing. The terminal housing is adapted to be inserted into the die-cast housing in response to the second sealing member being sleeved onto the terminal housing, with the second sealing component being pressed against and sealed between the terminal housing and the die-cast housing.

### BRIEF DESCRIPTION OF THE DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIGS. 1A and 1B illustrate a schematic perspective view and a schematic exploded view, respectively, of an exemplary 180-degree electrical connector according to an embodiment of the present disclosure.

FIGS. 2A and 2B illustrate a schematic perspective view and a schematic exploded view, respectively, of an exemplary 90-degree electrical connector according to another embodiment of the present disclosure.

FIG. 3 illustrates a schematic perspective view of a terminal in the 180-degree electrical connector as illustrated in FIG. 1A and FIG. 1B.

FIG. 4A to FIG. 4C illustrate schematic perspective views of a terminal housing in the 180-degree electrical connector as illustrated in FIG. 1A and FIG. 1B, observed from different viewing angles, respectively.

FIG. 5A and FIG. 5B illustrate schematic perspective views of a die-cast housing in the 180-degree electrical connector as illustrated in FIG. 1A and FIG. 1B, observed from different viewing angles.

FIG. 6 illustrates a schematic perspective view of a terminal in the 90-degree electrical connector as illustrated in FIG. 2A and FIG. 2B.

FIG. 7A to FIG. 7C illustrate schematic perspective views of a terminal housing in the 90-degree electrical connector as illustrated in FIG. 2A and FIG. 2B, observed from different viewing angles, respectively.

FIG. 8A and FIG. 8B illustrate schematic perspective views of a die-cast housing in the 90-degree electrical connector as illustrated in FIG. 2A and FIG. 2B, observed from different viewing angles.

FIG. 9A and FIG. 9B illustrate a schematic perspective view and a schematic exploded view, respectively, of a 180-degree electrical connector assembly according to an embodiment of the present disclosure.

FIG. 10A and FIG. 10B illustrate a schematic perspective view and a schematic exploded view, respectively, of a 90-degree electrical connector assembly according to another embodiment of the present disclosure.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

The present disclosure will now be described in detail with reference to the drawings, which are provided as illustrative examples of the present disclosure to enable those skilled in the art to practice the disclosure. It is to be noted that the following drawings and examples are not intended to limit the scope of the disclosure to a single embodiment, but other embodiments are possible by interchange of some or all of the described or illustrated elements. Moreover, where known components may be used partially or entirely to implement elements of the present disclosure, only those parts of such known components necessary for understanding the present disclosure will be described, and detailed descriptions of other parts of such known components will be omitted so as not to obscure the present disclosure. Unless otherwise specified herein, as will be understood by those skilled in the art, embodiments described as implemented in software should not be limited as such, but may include embodiments implemented in hardware or a combination of software and hardware, and vice versa. In this specification, embodiments showing singular components should not be considered to be limiting; rather, unless explicitly stated otherwise herein, the present disclosure is intended to encompass other embodiments including a plurality of the same components, and vice versa. Furthermore, the applicant does not intend that any term in the specification or claims are ascribed an uncommon or special meaning unless explicitly stated as such. Additionally, the present disclosure encompasses present and future known equivalents of the known components referred to herein by way of illustration.

Unless otherwise specified, “bottom” and “top”, “upper” and “lower”, etc., appearing in the content recorded in the present disclosure are relative concepts. And “corresponding” or “respective” appearing in the content recorded in the present disclosure refers to the correspondence between components that are used in pairs and work cooperatively.

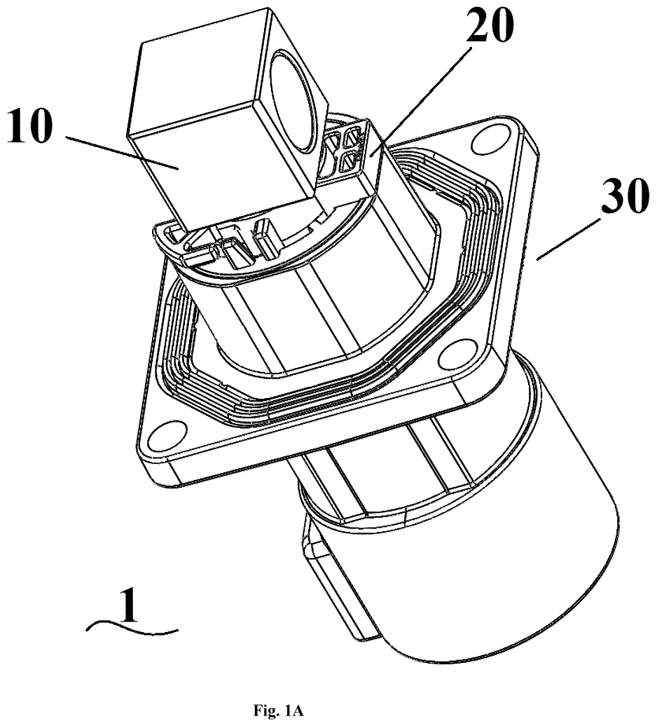

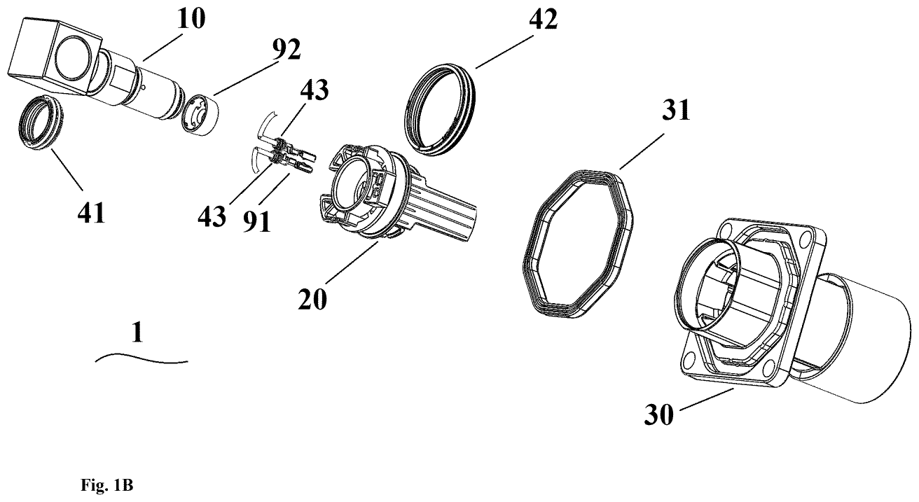

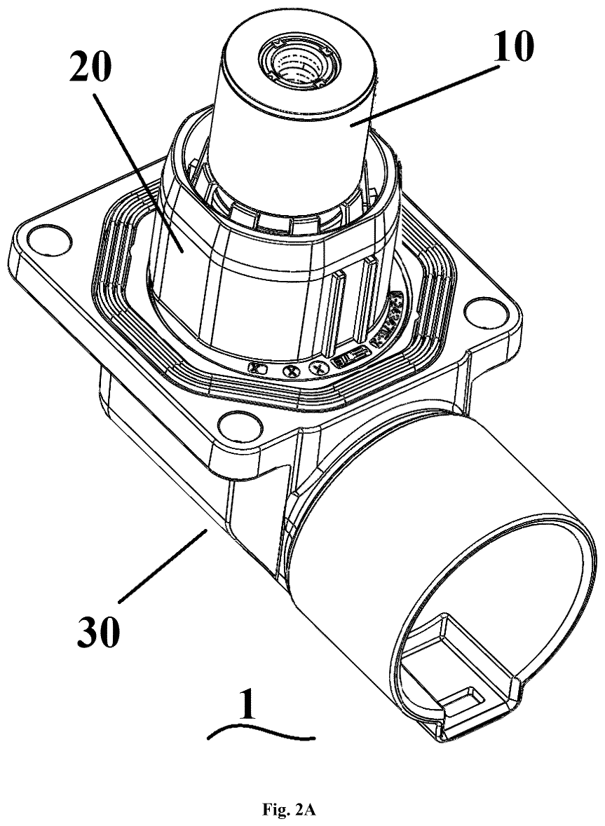

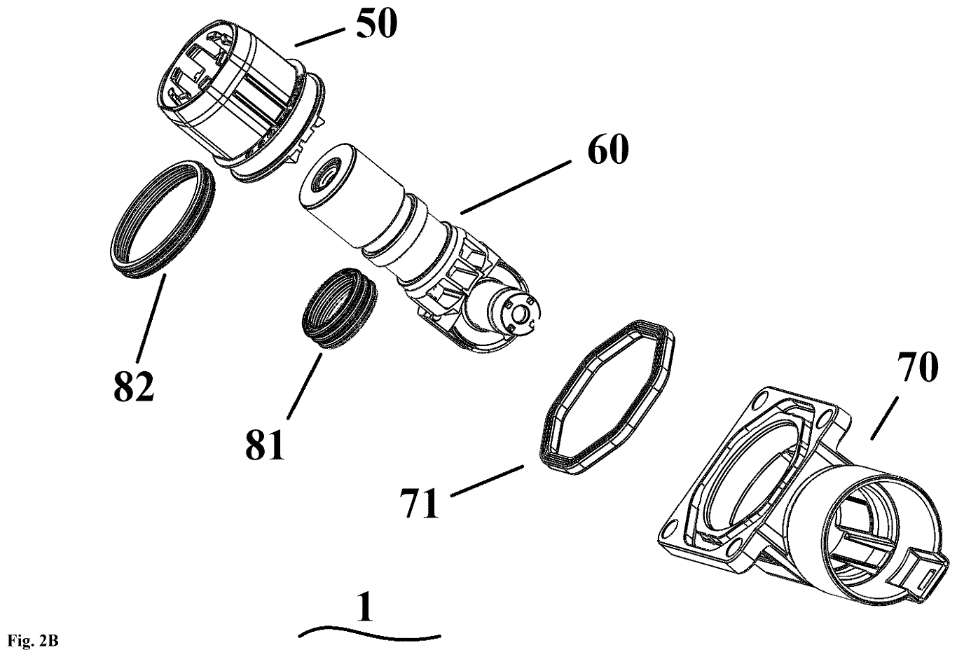

FIGS. 1A and 1B illustrate a schematic perspective view and a schematic exploded view, respectively, of an exemplary 180-degree electrical connector according to an embodiment of the present disclosure. FIGS. 2A and 2B illustrate a schematic perspective view and a schematic exploded view, respectively, of an exemplary 90-degree electrical connector according to another embodiment of the present disclosure.

In one aspect of the present disclosure, according to a general technical concept of the present disclosure, there is provided an electrical connector, including: a conductive terminal; an insulated terminal housing configured to at least partially accommodate the terminal; and a die-cast housing configured to at least partially accommodate the terminal housing. The electrical connector further includes: a first sealing component which is sleeved onto the terminal; and a second sealing component which is sleeved onto the terminal housing. The terminal is configured to be axially inserted in place into the terminal housing in response to the first sealing component being sleeved onto the terminal, with the first sealing component being pressed against and sealed between the terminal and the terminal housing. And the terminal housing is configured to be inserted in place into the die-cast housing in response to the second sealing member being sleeved onto the terminal housing, with the second sealing component being pressed against and sealed between the terminal housing and the die-cast housing.

As a specific exemplary embodiment, for example, as illustrated in FIG. 1A and FIG. 1B, there is provided an exemplary 180-degree electrical connector 1, including: a conductive terminal 10; an insulated terminal housing 20 configured to at least partially accommodate the terminal 10; and a die-cast housing 30 configured to at least partially accommodate the terminal housing 20. The electrical connector 1 further includes: a first sealing component 41, which is sleeved onto the terminal 10; and a second sealing component 42 which is sleeved onto the terminal housing 20. The terminal 10 is configured to be axially inserted in place into the terminal housing 20 in response to the first sealing component 41 being sleeved onto the terminal 10, with the first sealing component 41 being pressed against and sealed between the terminal 10 and the terminal housing 20. And the terminal housing 20 is configured to be inserted in place into the die-cast housing 30 in response to the second sealing member 42 being sleeved onto the terminal housing 20, with the second sealing component 42 being pressed against and sealed between the terminal housing 20 and the die-cast housing 30.

As an alternative exemplary embodiment, by way of example, as illustrated in FIG. 2A and FIG. 2B, there is provided an exemplary 90-degree electrical connector 1, including: a conductive terminal 50; an insulated terminal housing 60 configured to at least partially accommodate the terminal 50; and a die-cast housing 70 configured to at least partially accommodate the terminal housing 60. The electrical connector 1 further includes: a first sealing component 81 which is sleeved onto the terminal 50; and a second sealing component 82 which is sleeved onto the terminal housing 60. The terminal 50 is configured to be axially inserted in place into the terminal housing 60 in response to the first sealing component 81 being sleeved onto the terminal 50, with the first sealing component 81 being pressed against and sealed between the terminal 50 and the terminal housing 60. And the terminal housing 60 is configured to be inserted in place into the die-cast housing 70 in response to the second sealing member 82 being sleeved onto the terminal housing 60, with the second sealing component 82 being pressed against and sealed between the terminal housing 60 and the die-cast housing 70.

As such, based on such an arrangement, thereby between, for example, the terminal, the terminal housing, and the die-cast housing arranged successively from the inside to the outside, the first sealing component sleeved onto the innermost terminal is used to press against and seal between the terminal and the terminal housing; in turn the second sealing component sleeved onto the intermediate terminal housing is used to press against and seal between the terminal housing and the die-cast housing, thereby achieving superior self-sealing performance in electrical connectors such as 90-degree and 180-degree electrical connectors, and withstanding high voltage and/or high current and in turn the resulting high operating temperatures, avoiding problems of ATF oil leakage and ATF oil intolerance to high temperatures. Moreover, the self-sealing of the electrical connector as achieved using existing processes can essentially be considered as an integral sealing structure, which effectively controls costs while sufficiently ensuring sealing performance, without using potting compound composite material. Additionally, it also facilitates vibration reduction and/or vibration isolation for the electrical connector in high-vibration working environments under high vibration conditions.

According to an exemplary embodiment of the present disclosure, for example, the terminal housing is provided with a circumferential cylindrical wall that defines therein a hollow axial space which opens at both ends, with a space as defined by a first circumferential inner surface of the terminal housing at least partially accommodating the terminal; and the die-cast housing is hollow, with another space as defined by a second circumferential inner surface of the die-cast housing at least partially accommodating the terminal housing.

As a specific exemplary embodiment, by way of example, as illustrated in FIG. 1B, the terminal housing 20 is provided with a circumferential cylindrical wall 23 that defines therein a hollow axial space 22 which opens at both ends, whereby the terminal housing 20 is hollow and cylindrical, with a space as defined by a first circumferential inner surface 201 of the terminal housing at least partially accommodating the terminal 10; and the die-cast housing 30 is hollow, with another space as defined by a second circumferential inner surface 301 of the die-cast housing at least partially accommodating the terminal housing 20.

As an alternative exemplary embodiment, for example, as illustrated in FIG. 2B, the terminal housing 60 is provided with a circumferential cylindrical wall 63 that defines therein a hollow axial space 62 which opens at both ends, whereby the terminal housing 60 is hollow and cylindrical, with a space as defined by a first circumferential inner surface 601 of the terminal housing at least partially accommodating the terminal 50; and the die-cast housing 70 is hollow, with another space as defined by a second circumferential inner surface 701 of the die-cast housing at least partially accommodating the terminal housing 60.

More specifically, for example, the die-cast housing 70 itself includes two parts that are orthogonal to each other and communicating with each other, i.e., a hollow first die-cast housing section extending vertically and parallel to the axial direction and a hollow second die-cast housing section extending horizontally and perpendicular to the vertical direction. Furthermore, the die-cast housing may at least partially accommodate the terminal casing 60 with a portion of the space defined by inner surface areas of its second circumferential inner surface 701 within both the first die-cast housing section and the second die-cast housing section (more specifically, for example, parts of the space defined respectively by the entire inner surface area within the first die-cast housing section and by a portion of local inner surface area within the second die-cast housing section).

With such arrangements as in FIG. 1B for the 180-degree electrical connector and as in FIG. 2B for the 90-degree electrical connector, an integral accommodating structure of “terminal”-“terminal housing”-“die-cast housing”, which is in a multi-layer annular stack arrangement from the inside to the outside, is achieved.

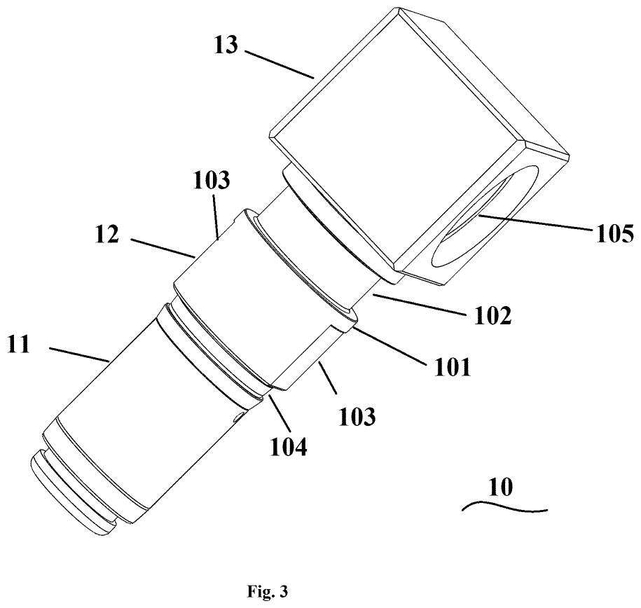

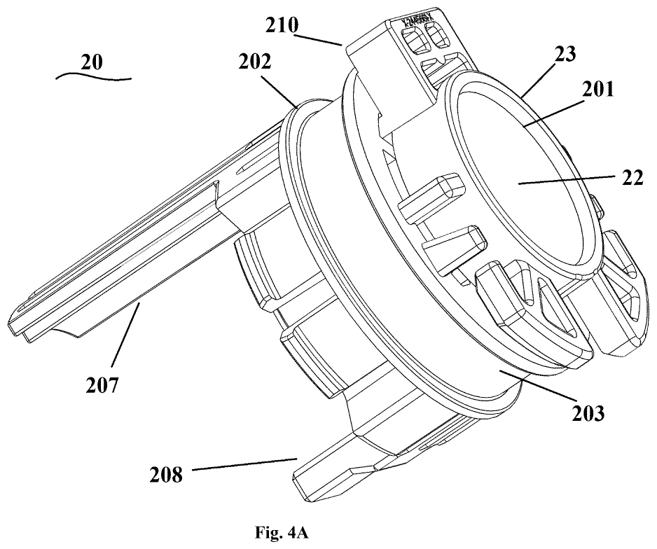

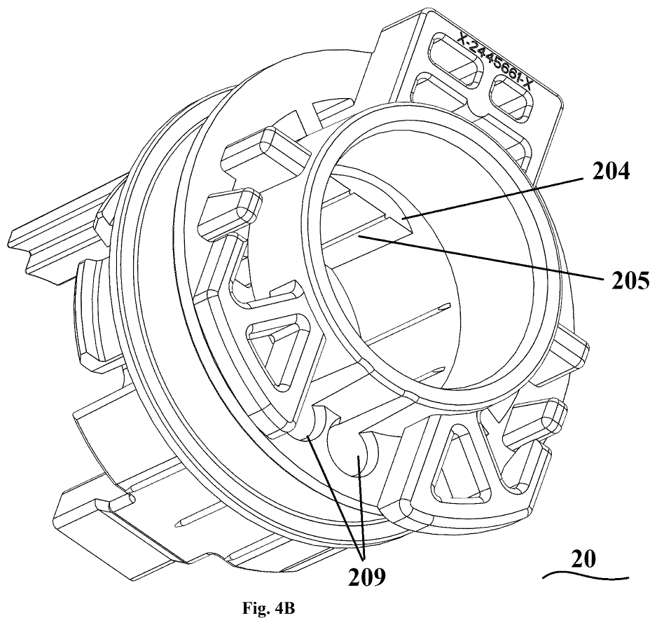

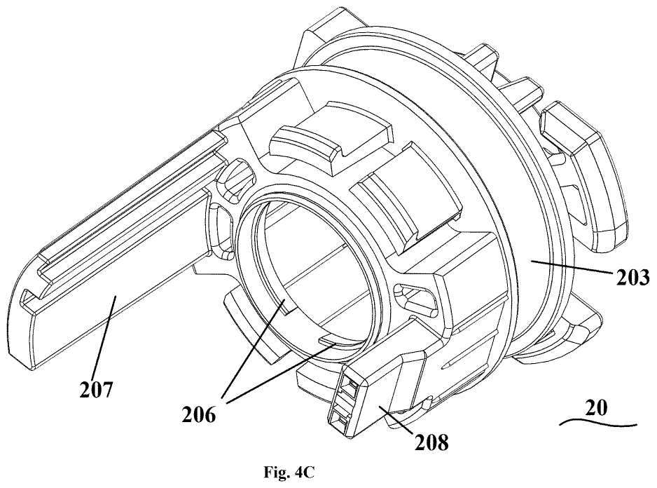

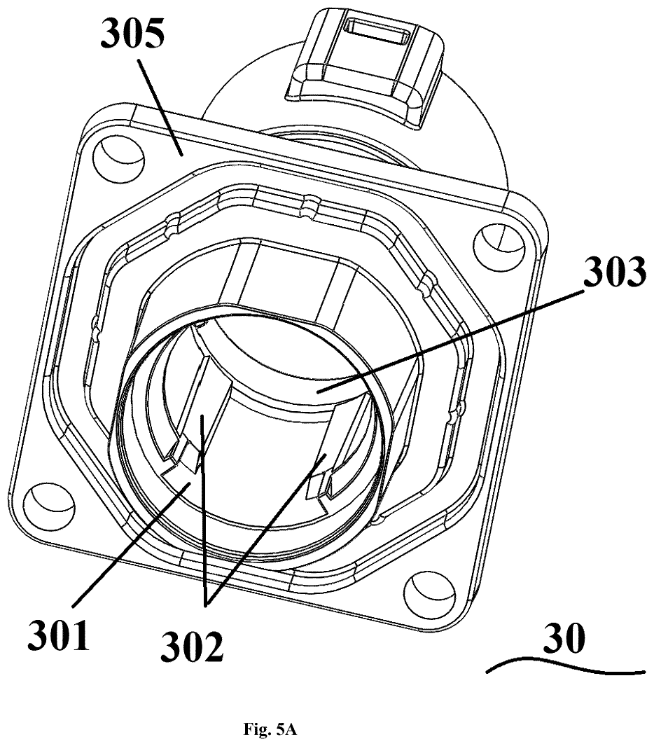

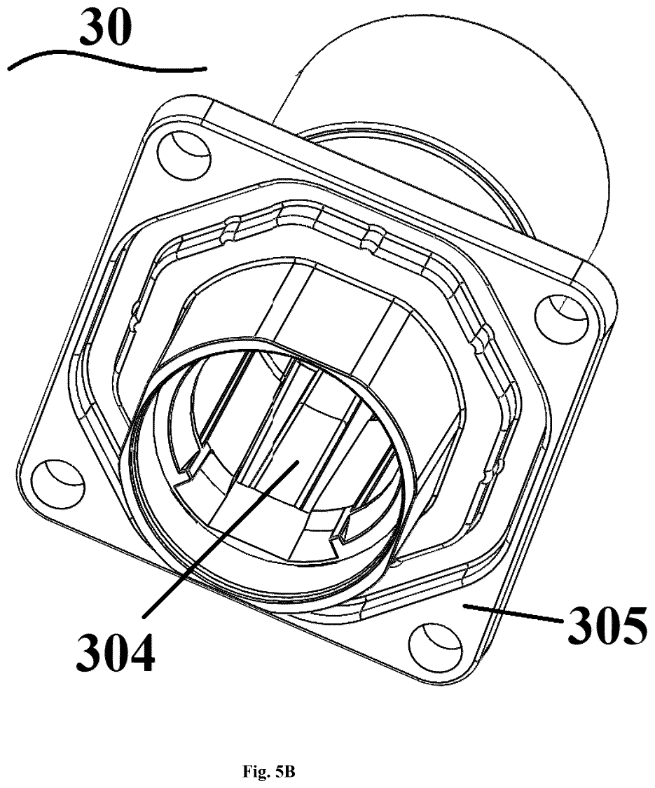

FIG. 3 illustrates a schematic perspective view of a terminal in the 180-degree electrical connector as illustrated in FIG. 1A and FIG. 1B. FIG. 4A to FIG. 4C illustrate schematic perspective views of a terminal housing in the 180-degree electrical connector as illustrated in FIG. 1A and FIG. 1B, observed from different viewing angles, respectively. FIG. 5A and FIG. 5B illustrate schematic perspective views of a die-cast housing in the 180-degree electrical connector as illustrated in FIG. 1A and FIG. 1B, observed from different viewing angles.

According to an exemplary embodiment of the present disclosure, as shown in FIGS. 3 and 4A to 4C, for example, the terminal 10 is provided with a first circumferential groove 102 which is annular and formed on a first circumferential outer surface 101 of the terminal 10 facing towards the first circumferential inner surface 201 of the terminal housing 20, and the first sealing component 41 is configured to seal, radially, against between the first circumferential outer surface 101 of the terminal 10 and the first circumferential inner surface 201 of the terminal housing 20 in a condition that the first sealing component 41 is snap-fitted to the first circumferential groove 102, so as to radially fill a first annular gap between the first circumferential outer surface 101 and the first circumferential inner surface 201. And, according to an exemplary embodiment of the present disclosure, as illustrated in FIG. 4A to FIG. 4C and FIG. 5A to FIG. 5B, for example, the terminal housing 20 is provided with a second circumferential groove 203 which is annular and formed on a second circumferential outer surface 202 of the terminal housing 20 facing towards the second circumferential inner surface 301 of the die-cast housing 30, and the second sealing component 42 is configured to seal, radially, against between the second circumferential outer surface 202 of the terminal housing 20 and the second circumferential inner surface 301 of the die-cast housing 30 in a condition that the second sealing component 42 is snap-fitted to second circumferential groove 203, so as to radially fill a second annular gap between the second circumferential outer surface 202 and the second circumferential inner surface 301. Thus, by this arrangement, based on a modular combination structure, a radially-filled integral self-sealing design for the 90-degree electrical connector 1 is realized, facilitating effective avoidance of, for example, leakage phenomena and degradation on electrical connection.

In a further embodiment, by way of example, the first circumferential groove 102 and the second circumferential groove 203 are arranged to be coaxial with each other. And/or, further, for example, the first sealing component 41 and the second sealing component 42 are arranged to be coaxial with each other.

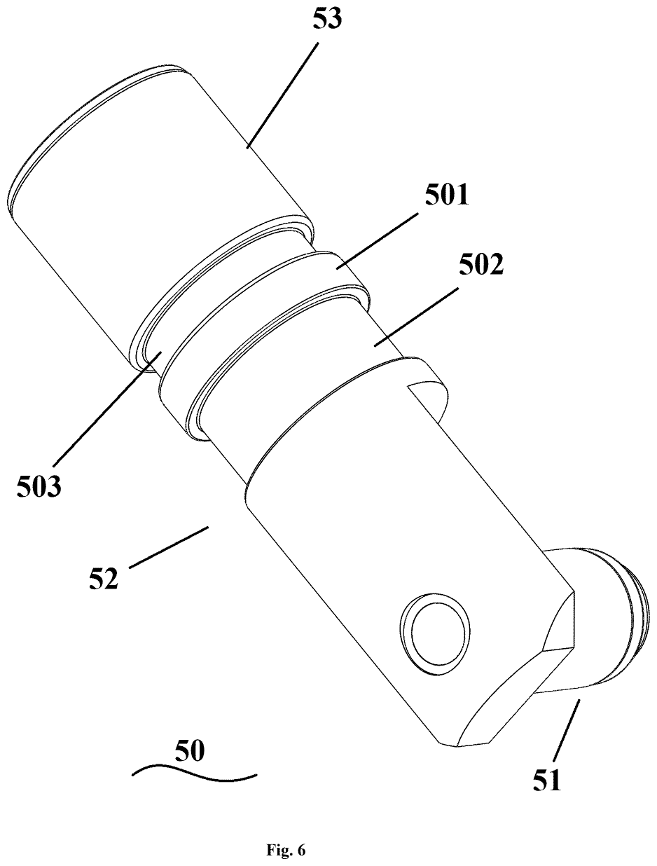

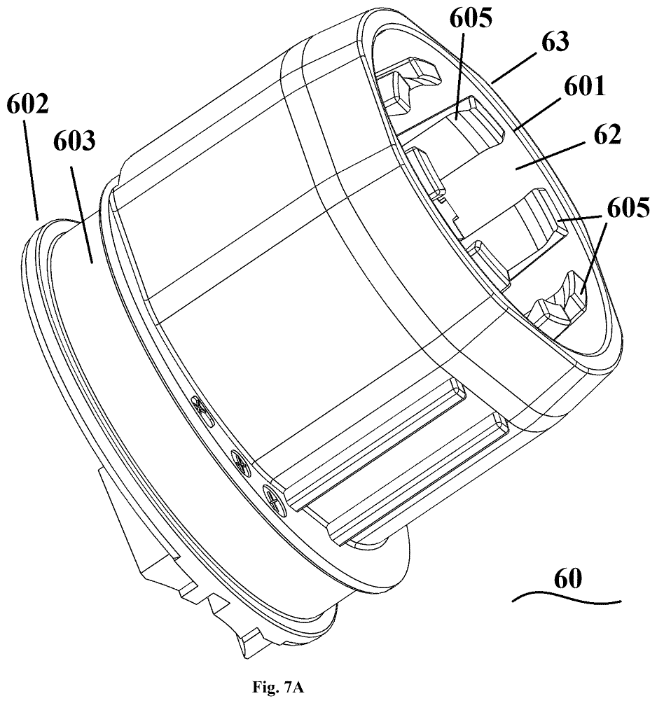

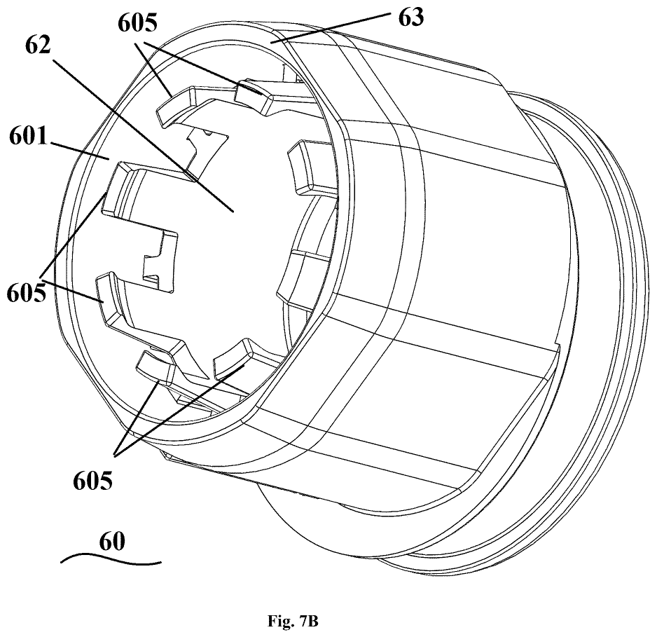

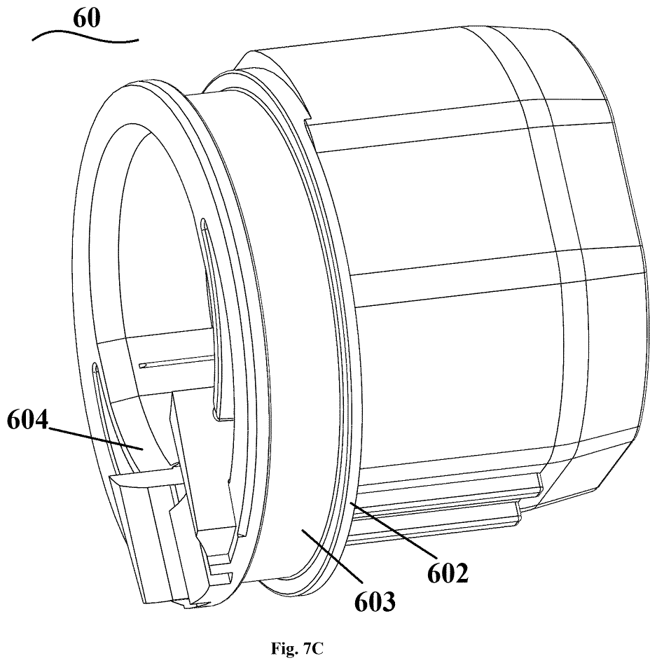

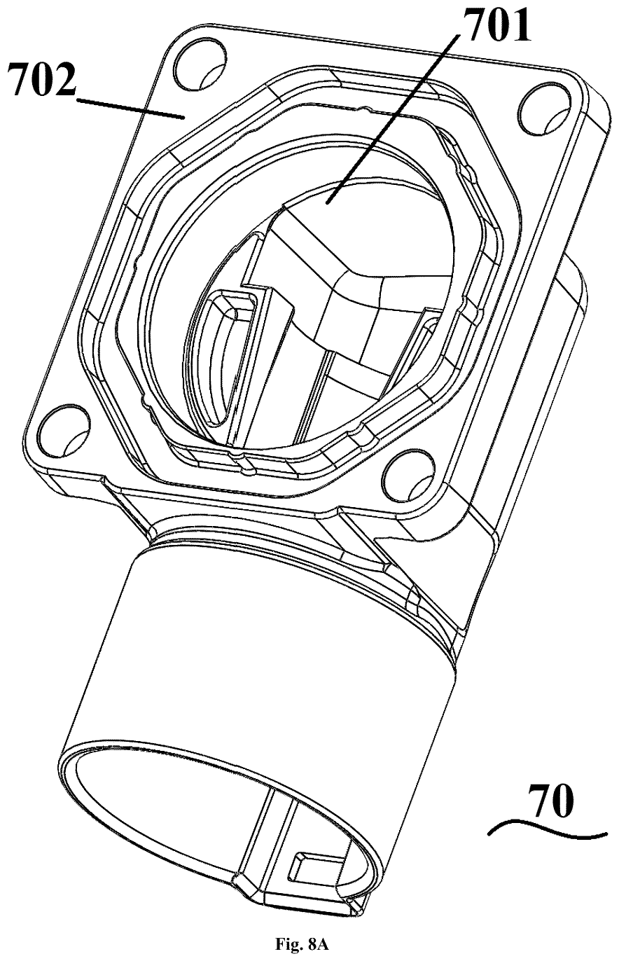

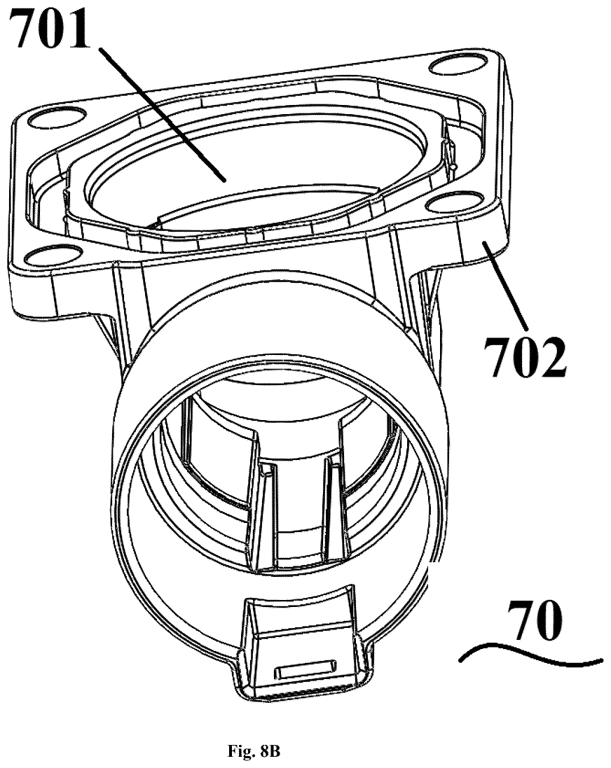

FIG. 6 illustrates a schematic perspective view of a terminal in the 90-degree electrical connector as illustrated in FIG. 2A and FIG. 2B. FIG. 7A to FIG. 7C illustrate schematic perspective views of a terminal housing in the 90-degree electrical connector as illustrated in FIG. 2A and FIG. 2B, observed from different viewing angles, respectively. FIG. 8A and FIG. 8B illustrate schematic perspective views of a die-cast housing in the 90-degree electrical connector as illustrated in FIG. 2A and FIG. 2B, observed from different viewing angles.

According to an alternative exemplary embodiment of the present disclosure, as illustrated in FIG. 6 and FIG. 7A to FIG. 7C, for example, the terminal 50 is provided with a first circumferential groove 502 which is annular and formed on a first circumferential outer surface 501 of the terminal 50 facing towards the first circumferential inner surface 601 of the terminal housing 60, and the first sealing component 81 is configured to seal against between the first circumferential outer surface 501 of the terminal 50 and the first circumferential inner surface 601 of the terminal housing 60 in a condition that the first sealing component 81 is snap-fitted to the first circumferential groove 502, so as to radially fill a first annular gap between the first circumferential outer surface 501 and the first circumferential inner surface 601. And, according to an exemplary embodiment of the present disclosure, as illustrated in FIG. 7A to FIG. 7C and FIG. 8A to FIG. 8B, for example, the terminal housing 60 is provided with a second circumferential groove 603 which is annular and formed on a second circumferential outer surface 602 of the terminal housing 60 facing towards the second circumferential inner surface 701 of the die-cast housing 70, and the second sealing component 82 is configured to seal against between the second circumferential outer surface 602 of the terminal housing 60 and the second circumferential inner surface 701 of the die-cast housing 70 in a condition that the second sealing component 82 is snap-fitted to second circumferential groove 603, so as to radially fill a second annular gap between the second circumferential outer surface 602 and the second circumferential inner surface 701. Thus, by this arrangement, based on a modular combination structure, a radially-filled integral self-sealing design for the 180-degree electrical connector 1 is realized, facilitating effective avoidance of, for example, leakage phenomena and degradation on electrical connection.

In a further embodiment, by way of example, the first circumferential groove 502 and the second circumferential groove 603 are arranged to be coaxial with each other. And further, for example, the first sealing component 81 and the second sealing component 82 are arranged to be coaxial with each other.

Thus, by this arrangement, based on a modular combination structure, an integrally coaxial radially-filled self-sealing design for electrical connectors such as the aforementioned 90-degree and 180-degree electrical connectors, is achieved, such that it is particularly suitable for reducing the influence of external vibration in a high-vibration working environment, facilitating maintenance of reliable integrated self-sealing against vibration effects. Moreover, for example, leakage phenomena and degradation on electrical connections are effectively avoided.

According to an exemplary embodiment of the present disclosure, referring back to FIG. 3, for example, the terminal 10 includes: a first section 11 extending through the terminal housing 20 and exposed from the terminal housing 20 into the die-cast housing 30; a second section 12 inserted within the terminal housing 20; and a third section 13 located at an end of the terminal 10 opposite to the first section 11 and exposed from the terminal housing 20.

In a further exemplary embodiment, as a specific example as illustrated in FIG. 3, the first circumferential groove 102 is formed at a portion of the second section 12 adjacent to the third section 13, and is provided with a cross section that shrinks in size radially as compared to the third section 13, for receiving and retaining in place the first sealing component 41 in the first circumferential groove 102.

Further, as a typical exemplary embodiment, for example, as illustrated in FIG. 3 and FIG. 4A to FIG. 4C, the terminal 10 is provided with a pair of first flat surfaces 103 formed on a portion of the second section 12 facing away from the third section 13 and spaced apart from the first circumferential groove 102, the pair of first flat surfaces 103 extending axially and facing each other radially; and the terminal housing 20 is formed therein with a pair of flat-top platforms 204 which projects radially inwards from the first circumferential inner surface 201 and facing towards each other radially, the pair of flat-top platforms 204 being adapted to press against the pair of first flat surfaces 103, respectively.

Correspondingly, as an example, as illustrated in FIG. 3 and FIG. 4A to FIG. 4C, the pair of flat-top platforms 204 are formed thereon with respective linear protrusions 205 extending axially and in parallel with each other for frictional contact with the pair of first flat surfaces 103, and the pair of flat-top platforms 204 and the pair of first flat surfaces 103 are configured to cooperate with each other with the frictional contact to perform both axial alignment and axial guidance of movement of the terminal 10 into the terminal housing 20.

With such arrangements, it is effectively achieved that the pair of flat-top platforms 204 and the pair of first flat surfaces 103 cooperate with each other through the frictional contact therebetween, thereby performing axial alignment and axial guidance for the movement of the terminal 10 inserted into the terminal housing 20, such that the alignment between the terminal 10 and the terminal housing 20 and the correction of the relative movement therebetween are effectively achieved, under the guidance of the pair of flat-top platforms 204, in particular the axial linear projection 205 additionally provided thereon, preventing unintended rotation of the terminal 10 during insertion into the terminal housing 20.

In a further exemplary embodiment, as a specific example as illustrated in FIG. 3 and FIG. 4A to FIG. 4C, the terminal housing 20 is further provided with a projection 206 that extends radially inwards from the first circumferential inner surface 201 of the terminal housing 20 and arranged at least partially circumferentially, and the terminal 10 is further provided with a third circumferential groove 104 which is annular and formed between the first section 11 and the second section 12 and adapted to accommodate the third circumferential groove 104 which is annular, of the projection 206; and the terminal 10 is inserted in place into the terminal housing 20, by the projection 206 being snap-fitted into the third circumferential groove 104 in response to a condition that the terminal 10 is inserted axially into the terminal housing 20. And, in a further embodiment, as an example, once the terminal 10 is inserted in place into the terminal housing 20, the aforementioned condition that the first sealing component is pressed against and sealed between the terminal and the terminal housing is achieved.

As such, by this arrangement, in a condition that the terminal 10 is inserted in place into the terminal housing 20, specifically by snapping the projection 206, which is provided on the inner side surface of the terminal housing 20, into the third circumferential groove 104, accidental/unintended withdrawal of the terminal 10 (e.g. due to external vibration or unintended outward pulling force acting on the tail portion of the terminal 10) is avoided, serving as retraction stop, i.e., implementing an anti-withdrawal function.

According to an alternative exemplary embodiment of the present disclosure, referring back to FIG. 6, for example, the terminal 50 includes: a first section 51 extending through the terminal housing 60 and exposed from the terminal housing 60 into the die-cast housing 70; a second section 52 inserted within the terminal housing 60; and a third section 53 located at an end of the terminal 50 opposite to the first section 51 and exposed from the terminal housing 60.

In a further exemplary embodiment, as a specific example as illustrated in FIG. 6, the first circumferential groove 502 is formed at a portion of the second section 52 adjacent to the third section 53, and is provided with a cross section that shrinks in size radially as compared to the third section 53, for receiving and retaining in place the first sealing component 81 in the first circumferential groove 502.

Further, as a typical exemplary embodiment, for example, as illustrated in FIG. 6 and FIG. 7A to FIG. 7C, the terminal housing 60 is further provided with a radial ridge 604 that extends inwards from the circumferential cylindrical wall 63, and a plurality of cantilever members 605 extending axially towards the third section 53 from an annular end surface of the radial ridge 604 facing away from the die-cast housing 70. The plurality of cantilever members 605 are circumferentially spaced apart from each other and deflectable radially inwardly, respectively.

Accordingly, in an example, as illustrated in FIGS. 6 and 7A to 7C, the terminal 50 is further provided with a circumferential engagement groove 503 formed on the second section 52 between the first circumferential groove 502 and the third section 53 and adapted to frictionally contact with respective free ends of the plurality of cantilever members 605.

In a further exemplary embodiment, as a specific example as illustrated in FIG. 6 and FIG. 7A to FIG. 7C, the terminal 50 is inserted in place into the terminal housing 60, by the plurality of cantilever members 605 frictionally contacting with and pressing against, at respective free ends thereof, inner wall of the circumferential engagement groove 503 of the second section 52 in response to a condition that the terminal 50 is axially inserted into the terminal housing 60. And, in a further embodiment, by way of example, once the terminal 50 is axially inserted in place into the terminal housing 60, the aforementioned condition that the first sealing component is pressed against and sealed between the terminal and the terminal housing is achieved.

With this arrangement, based on the plurality of cantilever members 605 which extend axially toward the third section 53 from the annular end face of the radial ridge 604 facing away from the cast casing 70 and deflect radially inward (more specifically, respective free ends bending and deflecting radially inward) and are spaced apart circumferentially (more preferably, for example, evenly spaced apart), during the insertion of the terminal 50 into the terminal housing 60, particularly when the terminal 50 is inserted in place into the terminal housing 60, it is effectively achieved that, the plurality of cantilever beams frictionally contact and press against the inner wall of the circumferential engagement groove 503 of the second section 52 with their respective deflected free ends, thereby firmly and reliably engaging and retaining the terminal 50 within the circumferential engagement groove 503, and in turn accidental/unintended withdrawal of the terminal 50 (e.g., due to external vibration or a force applied to the tail end of the terminal 50) is avoided, serving as retraction stop, i.e., implementing an anti-withdrawal function.

As a specific exemplary embodiment, for example, as illustrated in FIG. 7A and FIG. 7B, each cantilever member 605 is provided with a cross section which is radially inwards and in a form of inverted T-shaped. A cantilever beam having such an inverted T-shaped cross-sectional shape have better bending resistance and torsional stiffness as compared to a cantilever beam having rectangular cross-section, making it particularly suitable for realizing long-span cantilever beams.

In an exemplary embodiment, by way of example, the plurality of cantilever beams each having an inverted T-shaped cross-section are eccentrically arranged relative to the terminal 50 to be inserted, for example, the plurality of cantilever members 605 are also arranged eccentrically relative to the circumferential cylindrical wall 63, such that during initial insertion, the terminal 50 locally applies a larger force on a portion of the plurality of cantilever beams, and as the insertion process proceeds, the force applied by the terminal 50 is gradually distributed evenly to, for example, the plurality of cantilever beams preferably evenly arranged circumferentially, thereby achieving uniform distribution of the force from the terminal 50 being inserted, on the inner surface of the terminal housing 60.

According to an exemplary embodiment of the present disclosure, as shown in FIG. 4A to FIG. 4C, for example, the terminal housing 20 is further provided with a first tab 207 which extends axially from a portion of a circumferential edge of the terminal housing 20 at a distal end thereof facing away from the terminal 10, the first tab 207 being provided with a fan-ring shaped cross section.

Accordingly, by way of example, as illustrated in FIG. 4A to FIG. 4C and FIG. 5A to FIG. 5B, the die-cast housing 30 is further provided with: two first retaining features 302, for example in the form of protrusions, which project radially inwards from the second circumferential inner surface 301 and circumferentially spaced apart from each other, the two first retaining features 302 being adapted to retain and restrict circumferentially the first tab 207 therebetween and configured to cooperate with each other to guide the first tab 207 axially into the die-cast housing 30 and to function as a circumferential retainer which rotates circumferentially against a circumferential rotation of the first tab 207; and a second retaining feature 303 which for example projects radially inwards from inside of the die-cast housing 30 and arranged at least partially circumferentially, and located at a distal end of the two first retaining features 302 facing away from the terminal 10. The second retaining feature 303 functions as an axial stop for the first tab 207 being axially inserted into the die-cast housing 30.

In a further exemplary embodiment, as a specific example shown in FIG. 4A to FIG. 4C and FIG. 5A to FIG. 5B, the terminal housing 20 is inserted in place into the die-cast housing 30, by the first tab 207 being snap-fitted between the two first retaining features 302 in response to a condition that the terminal housing 20 is inserted axially into the die-cast housing 30 until it is blocked by the second retaining feature 303. And, in a further embodiment, by way of example, once the terminal housing 20 is axially inserted in place into the die-cast housing 30, then the aforementioned condition that the second sealing component is pressed against and sealed between the terminal housing and the die-cast housing is achieved.

With this arrangement, by means of the two first retaining features, for example in the form of protrusions, as provided on the inner surface of the die-cast housing 30, the first tab 207 is restricted circumferentially therebetween, thereby achieving constraint on the insertion of the first tab 207, and in turn guiding the insertion movement of the terminal housing 20 relative to the die-cast housing 30, facilitating a smooth and unobstructed directional insertion without unintended deviation of the terminal housing 20, and also preventing unintended rotation of the terminal housing 20 during insertion into the die-cast housing 30, thereby achieving an anti-rotation stop function.

Further, by way of example, as illustrated in FIG. 4A and FIG. 4B, a concave-convex structure is for example further provided on the surface of the first tab 207, and accordingly, in a mating electrical connector 1 for paired connection with the electrical connector 1, for example, a mating concave-convex structure is also correspondingly provided on a component or part to be engaged with the first tab 207 to form a positive fit (i.e., a shape fit) with the concave-convex structure, thereby achieving a fool-proofing function of preventing inappropriate assembly.

And, according to an additional or alternative exemplary embodiment of the present disclosure, as shown in FIG. 4A to FIG. 4C, for example, the terminal housing 20 is further provided with a second tab 208 which extends axially from a portion of a circumferential edge of the terminal housing 20 at a distal end facing away from the terminal 10, the second tab 208 being arranged to be radially opposite to the first tab 207 and being provided with a fan-ring shaped cross section.

Accordingly, as an example, as shown in FIG. 4A to FIG. 4C and FIG. 5A to FIG. 5B, the die-cast housing 30 is further provided with an axial groove 304 which partially recessed radially from the second circumferential inner surface 301, the axial groove 304 extending axially away from the terminal housing 20 from a circumferential edge of the die-cast housing 30 at one end thereof facing towards the terminal housing 20, and the axial groove 304 being adapted to receive the second tab 208.

With this arrangement, by means of the axial groove 304 as provided on the inner surface of the die-cast housing 30, the second tab 208 is restricted circumferentially within the axial groove, thereby also achieving constraint on the insertion of the second tab 208, and in turn guiding the insertion movement of the terminal housing 20 relative to the die-cast housing 30, facilitating a smooth and unobstructed directional insertion without unintended deviation of the terminal housing 20, and also preventing unintended rotation of the terminal housing 20 during insertion into the die-cast housing 30, thereby achieving an anti-rotation stop function.

Further, by way of example, as illustrated in FIG. 4A and FIG. 4B, a second concave-convex structure is for example further provided on the surface of the second tab 208, and accordingly, in a mating electrical connector 1 for paired connection with the electrical connector 1, for example, a second mating concave-convex structure is also correspondingly provided on a component or part to be engaged with the second tab 208 to form a positive fit (i.e., a shape fit) with the second concave-convex structure, thereby achieving a fool-proofing function of preventing inappropriate assembly.

In a further embodiment, as an example, for example, referring back to FIG. 1A and FIG. 1B, in the 180-degree electrical connector 1, the electrical connector 1 further includes at least one high-voltage interlocking (HVIL) terminal 91 arranged to extend through a channel 209 which is embedded in the second tab 208 and a portion of a circumferential edge of the terminal housing 20 axially aligned with the second tab 208.

Further, by way of example, the electrical connector 1 further includes at least one third seal 43, each third seal 43 being sleeved over a respective one high-voltage interlocking terminal 91 and being press against and sealed between an outer surface of the respective one high-voltage interlocking terminal 91 and an inner surface of the channel 209.

With this arrangement, an effective sealing is also achieved for the high-voltage interlocking (HVIL) terminal 10, thereby further ensuring a reliable integrated self-sealing for the 180-degree electrical connector 1.

In a further exemplary embodiment, referring back to FIG. 4A to FIG. 4C, as a specific example, the second tab 208 extends axially away from the terminal 10, by a length shorter than that of the first tab 207. This arrangement is due to the fact that the HVIL terminal 10 is arranged to be embedded within the second tab 208 for mating engagement with a component or portion of the mating electrical connector 1 to be engaged with the second tab 208, thus the second tab 208 has a relatively less strength as compared with the first tab 207. Thereby, the first tab 207 functions as a primary guide for the terminal case 20 to be inserted into the cast case 30, while the second tab 208 functions as an auxiliary guide.

According to an exemplary embodiment of the present disclosure, as shown in FIG. 4A to FIG. 4C and FIG. 5A to FIG. 5B, for example, the terminal housing 20 is further provided with a boss 210 which is located between an end of the terminal housing 20 facing away from the die-cast housing 30 and the second circumferential groove 203 and extends radially outwards, and the boss 210 is axially aligned with the first tab 207.

With this arrangement, in a condition that the terminal housing 20 is inserted in place into the die-cast housing 30, an additional stop is provided at the end of the terminal housing 20 facing away from the direction of insertion movement thereof which is directed towards the die-cast housing 30, functioning to prevent insertion of the terminal housing 20 beyond allowable stroke during assembly, and in turn the boss 210 essentially functions as a stroke limiter to avoid excessive insertion of the terminal housing 20 into the molded housing 30 which may result in unintended internal squeezing within the electrical connector 1. And since the boss 210 is axially aligned with the first tab 207, in case that the first tab 207 functions as an insertion guide for the front end of the terminal housing 20, the boss 210 functions as a stroke restriction for the rear end of the terminal case 20, and both cooperate with each other to ensure stroke control functionality in an axial line connecting the first tab 207 and the boss.

According to an exemplary embodiment of the present disclosure, as illustrated in FIG. 3, for example, the third section 13 is provided with a threaded hole 105 for mounting the electrical connector 1 in place via a threaded connection passing therethrough. As a result, a connection fixation of the electrical connector 1 at the site of use is achieved.

According to an exemplary embodiment of the present disclosure, as shown in FIG. 1A, FIG. 1B, and FIG. 3, for example, the electrical connector 1 further includes an insulating protective shield 92 screwed onto the free end of the first section 11 of the terminal 10. The electrical insulation performance of the protective shield 92 ensures that, for example, when a user's finger is inserted through both the die-cast housing 30 and the terminal housing 20 and contacts the protective shield 92, direct contact and unintended electrically conductive connection between the finger and the terminal 10 are avoided, thereby meeting the direct contact protection requirements, for example, as specified in GB 18384-2020 “Safety Requirements for Electric Vehicles”, preventing fingers from directly contacting the metal terminal 10 and avoiding resulting injury.

According to an exemplary embodiment of the present disclosure, for example, in the die-cast housing 30 of the 180-degree electrical connector 1 as illustrated in FIG. 5A and FIG. 5B, the die-cast housing 30 has a first flange portion 305 protruding laterally outwards around the outer side thereof in the circumferential direction, for example, for dividing the electrical connector 1 into a plug-in side for plug-in mating with a mating electrical connector 1 and an opposite mounting side for mounting to equipment, and has, for example, a rectangular or square cross-section for example as illustrated for mounting the electrical connector 1. As an example, the first flange portion 305 is provided with a plurality of threaded holes 105 for mounting via threaded connections. As an example, a planar annular face seal 31 is formed on the first flange portion 305.

According to an exemplary embodiment of the present disclosure, for example, in the die-cast housing 70 of the 90-degree electrical connector 1 as shown in FIG. 8A and FIG. 8B, the die-cast housing 70 has a second flange portion 702 protruding transversely outward around the outer side thereof in the circumferential direction, for example, for dividing the electrical connector 1 into a plug-in side for plug-in mating with a mating electrical connector 1 and an opposite mounting side for mounting to equipment, and has, for example, a rectangular or square cross-section for example as illustrated for mounting the electrical connector 1. As an example, the second flange portion 702 is provided with a plurality of threaded holes for mounting via threaded connections. As an example, a planar annular face seal 71 is formed on the second flange portion 702.

Based on the electrical connectors such as the 180-degree electrical connector and the 90-degree electrical connector provided above, the following superior technical effects over solutions in the related art can be achieved:

Based on the structure and assembly setting of such an electrical connectors, for example, an integrally coaxial radially-filled self-sealing design, which is based on a modular combination structure as achieved using existing processes, is suitable for application in high-voltage environments, and meets testing requirements such as high vibration and high current, and is applicable to inverter application scenarios involving high-voltage circuits with ATF oil. Moreover, the modular design of the structure also facilitates cost reduction, and thus can also broaden the application fields of electrical connector products in the market.

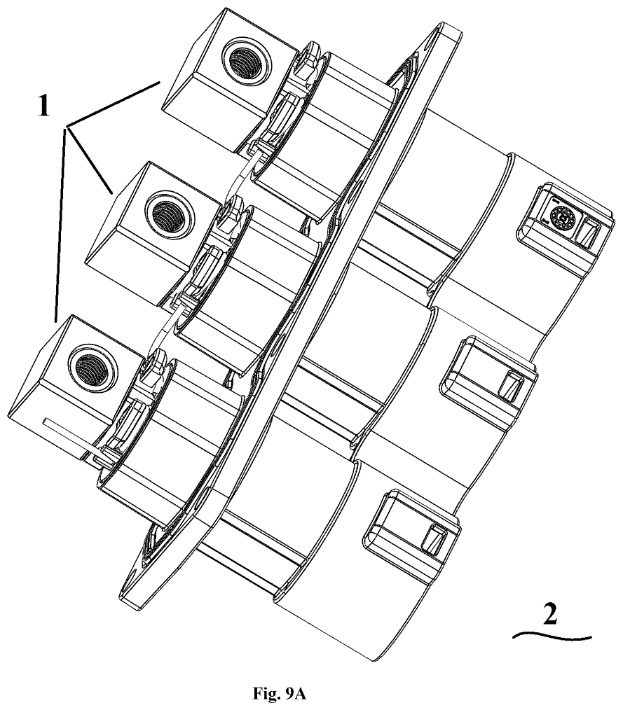

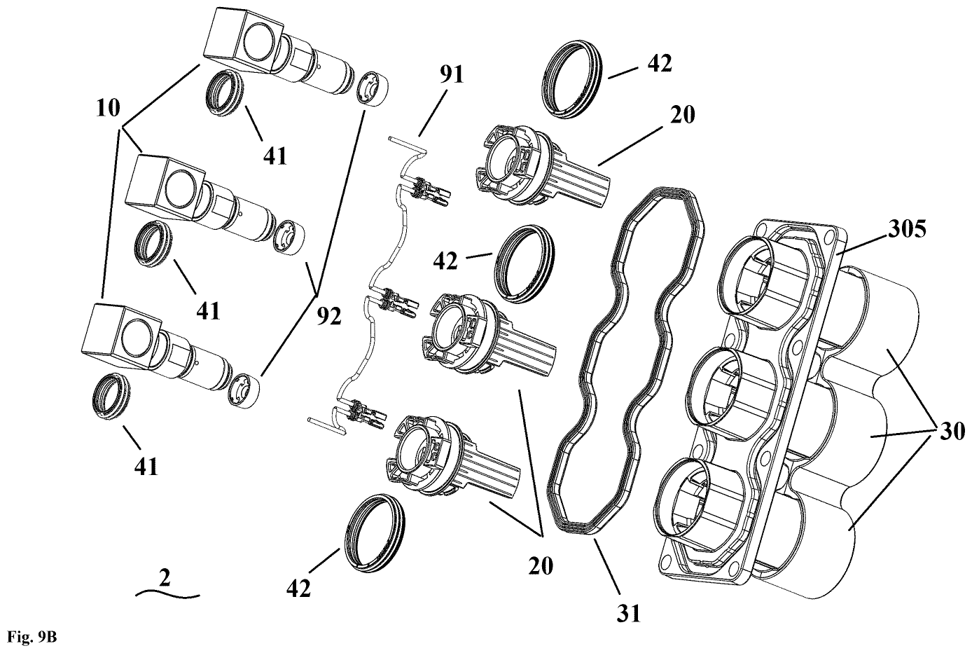

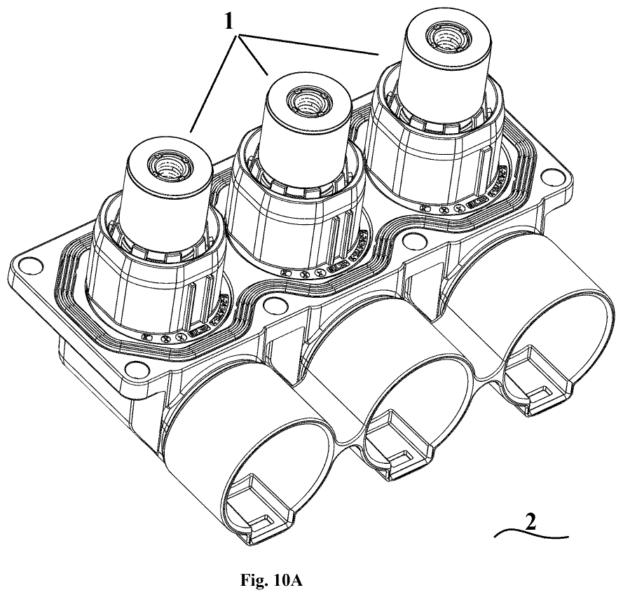

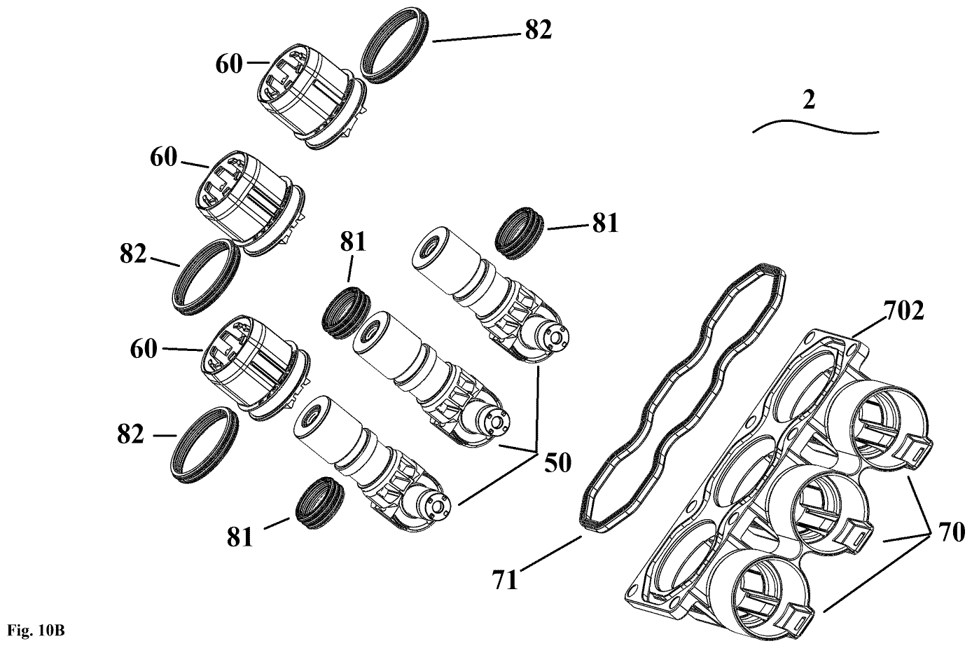

FIG. 9A and FIG. 9B illustrate a schematic perspective view and a schematic exploded view, respectively, of a 180-degree electrical connector assembly according to an embodiment of the present disclosure. FIG. 10A and FIG. 10B illustrate a schematic perspective view and a schematic exploded view, respectively, of a 90-degree electrical connector assembly according to another embodiment of the present disclosure.

In another aspect of the present disclosure, according to a general technical concept of the present disclosure, for example, as illustrated, an electrical connector assembly is also provided. The electrical connector assembly includes at least two electrical connectors each according to the foregoing, respective die-cast housing of the at least two electrical connectors being collectively integrally formed.

As a specific exemplary embodiment, for example, as illustrated in FIG. 9A and FIG. 9B, an exemplary electrical connector assembly 2 is provided. The electrical connector assembly 2 includes at least two of the aforementioned 180-degree electrical connectors 1, respective die-cast housings 30 of the at least two electrical connectors 1 being collectively integrally formed.

In an exemplary embodiment, as an example, for example as illustrated, the electrical connector assembly 2 is provided with three of the aforementioned 180-degree electrical connectors 1 arranged side by side, i.e., arranged in parallel, and their respective first flange portions 305 are integrally connected or integrally formed with each other. Accordingly, the planar annular face seals 31 on the respective first flange portions 305 of the three aforementioned 180-degree electrical connectors are collectively formed into a single closed annular face seal.

In an exemplary embodiment, by way of example, as illustrated, the high-voltage interlocking terminals of the three aforementioned 180-degree electrical connectors are electrically connected to each other.

As an alternative exemplary embodiment, for example as shown in FIG. 10A and FIG. 10B, there is provided an exemplary electrical connector assembly 2 including at least two 90-degree electrical connectors 1 according to the foregoing, respective die-cast housings 70 of the at least two electrical connectors 1 being collectively integrally formed.

In an exemplary embodiment, as an example, for example as illustrated, the electrical connector assembly 2 has three of the aforementioned 90-degree electrical connectors 1 arranged side by side, i.e., arranged in parallel, and their respective first flange portions are integrally coupled or integrally formed with each other. Accordingly, the planar annular face seals 71 on the respective second flange portions 702 of the three aforementioned 90-degree electrical connectors are collectively formed into a single closed annular face seal.

Furthermore, considering that the electrical connector assembly provided in another aspect of the present disclosure includes the aforementioned electrical connectors, it thus also possesses the advantages of the aforementioned electrical connectors, which will not be repeated here any more.

The above descriptions of the respective solutions of the electrical connector and electrical connector assembly in the foregoing embodiments of the present disclosure are intended to be illustrative, rather than restrictive. Although the present disclosure has been described with reference to the accompanying drawings, the embodiments as disclosed in the drawings are intended to exemplify the preferred embodiments of the present disclosure and should not be construed as a limitation thereof.

Therefore, those skilled in the art will understand that the embodiments described above are exemplary, and those skilled in the art can make improvements. Structures described in various embodiments can be modified and freely combined without conflict in structure or principle. These changes should fall within the protection scope of the present disclosure.

The breadth and scope of the present disclosure should not be limited by any of the above-described exemplary embodiments, but should be defined only in accordance with the following claims and their equivalents.

It should be noticed that the wording “comprising” does not exclude other components or steps, and the wording “a/an” or “one” does not exclude multiple or more than one. Furthermore, any reference numeral(s) in the claims should not be construed to be limitation of the scope of the present disclosure.

1. An electrical connector, comprising:
a conductive terminal;
an insulated terminal housing at least partially accommodating the terminal;
a die-cast housing at least partially accommodating the terminal housing;
a first sealing component sleeved onto the terminal, the terminal adapted to be axially inserted into the terminal housing in response to the first sealing component being sleeved onto the terminal, with the first sealing component being pressed against and sealed between the terminal and the terminal housing; and
a second sealing component sleeved onto the terminal housing, the terminal housing adapted to be inserted into the die-cast housing in response to the second sealing member being sleeved onto the terminal housing, with the second sealing component being pressed against and sealed between the terminal housing and the die-cast housing.

2. The electrical connector according to claim 1, wherein:
the terminal housing includes a circumferential cylindrical wall defining therein a hollow axial space which opens at both ends, with a space defined by a first circumferential inner surface of the terminal housing at least partially accommodating the terminal; and
the die-cast housing is hollow, with another space as defined by a second circumferential inner surface of the die-cast housing at least partially accommodating the terminal housing.

3. The electrical connector according to claim 2, wherein:
the terminal includes a first circumferential groove which is annular and formed on a first circumferential outer surface of the terminal facing towards the first circumferential inner surface of the terminal housing, and the first sealing component is adapted to seal, radially, against between the first circumferential outer surface of the terminal and the first circumferential inner surface of the terminal housing as the first sealing component is snap-fitted to the first circumferential groove; and
the terminal housing includes a second circumferential groove which is annular and formed on a second circumferential outer surface of the terminal housing facing towards the second circumferential inner surface of the die-cast housing, and the second sealing component is adapted to seal, radially, against between the second circumferential outer surface of the terminal housing and the second circumferential inner surface of the die-cast housing as the second sealing component is snap-fitted to second circumferential groove.

4. The electrical connector according to claim 3, wherein at least one of:
the first circumferential groove and the second circumferential groove are arranged coaxially with each other; and
the first sealing component and the second sealing component are arranged coaxially with each other.

5. The electrical connector according to claim 3, wherein the terminal comprises:
a first section extending through the terminal housing and exposed from the terminal housing into the die-cast housing;
a second section inserted within the terminal housing; and
a third section located at an end of the terminal opposite to the first section and exposed from the terminal housing.

6. The electrical connector according to claim 5, wherein the first circumferential groove is formed at a portion of the second section adjacent to the third section, and includes a cross section that reduces in size radially as compared to the third section.

7. The electrical connector according to claim 5, wherein:
the terminal is provided with a pair of first flat surfaces formed on a portion of the second section facing away from the third section and spaced apart from the first circumferential groove, the pair of first flat surfaces extending axially and facing each other in a radial direction; and
the terminal housing is formed therein with a pair of flat-top platforms which project radially inwards from the first circumferential inner surface and facing towards each other in a radial direction, the pair of flat-top platforms adapted to press against the pair of first flat surfaces, respectively.

8. The electrical connector according to claim 7, wherein:
the pair of flat-top platforms are formed thereon with respective linear protrusions extending radially and in parallel with each other and adapted for frictional contact with the pair of first flat surfaces, and
the pair of flat-top platforms and the pair of first flat surfaces are adapted to cooperate with each other with the frictional contact to perform both axial alignment and axial guidance of movement of the terminal into the terminal housing.

9. The electrical connector according to claim 7, wherein:
the terminal housing further includes a projection extending radially inwards from the first circumferential inner surface of the terminal housing and arranged at least partially circumferentially, and the terminal further includes a third circumferential groove which is annular and formed between the first section and the second section and adapted to accommodate the third circumferential groove which is annular, of the projection; and
the terminal is inserted into the terminal housing by the projection being snap-fitted into the third circumferential groove as the terminal is inserted axially into the terminal housing.

10. The electrical connector according to claim 5, wherein the terminal housing further includes:
a radial ridge extending inwards from the circumferential cylindrical wall; and
a plurality of cantilever members extending axially towards the third section from an annular end surface of the radial ridge facing away from the die-cast housing, the plurality of cantilever members circumferentially spaced apart from each other and deflectable radially inwardly, respectively.

11. The electrical connector according to claim 10, wherein the terminal further includes a circumferential engagement groove formed on the second section between the first circumferential groove and the third section and adapted to frictionally contact with respective free ends of the plurality of cantilever members.

12. The electrical connector according to claim 11, wherein the terminal is inserted in place into the terminal housing by the plurality of cantilever members frictionally contacting with and pressing against, at respective free ends thereof, inner wall of the circumferential engagement groove of the second section in response to the terminal being axially inserted into the terminal housing.

13. The electrical connector according to claim 11, wherein each cantilever member includes a cross section which extends radially inwards and is in a form of inverted T-shaped.

14. The electrical connector according to claim 3, wherein the terminal housing further includes a first tab which extends axially from a portion of a circumferential edge of the terminal housing at a distal end thereof facing away from the terminal, the first tab having a fan-ring shaped cross section.

15. The electrical connector according to claim 14, wherein the die-cast housing further includes:
two first retaining features projecting radially inwards from the second circumferential inner surface and circumferentially spaced apart from each other, the two first retaining features adapted to retain and restrict circumferentially the first tab therebetween and cooperating with each other to guide the first tab axially into the die-cast housing and to function as a circumferential retainer against a circumferential rotation of the first tab; and
a second retaining feature projecting radially inwards from inside of the die-cast housing and arranged at least partially circumferentially, and located at a distal end of the two first retaining features facing away from the terminal, the second retaining feature functioning as an axial stop for the first tab being axially inserted into the die-cast housing.

16. The electrical connector according to claim 15, wherein the terminal housing is inserted into the die-cast housing by the first tab being snap-fitted between the two first retaining features in response to the terminal housing being inserted axially into the die-cast housing until it is blocked by the second retaining feature.

17. The electrical connector according to claim 15, wherein the terminal housing further includes a second tab extending axially from a portion of a circumferential edge of the terminal housing at a distal end facing away from the terminal, the second tab arranged radially opposite to the first tab and provided with a fan-ring shaped cross section.

18. The electrical connector according to claim 17, wherein the die-cast housing further includes an axial groove partially recessed radially from the second circumferential inner surface, the axial groove extending axially away from the terminal housing from a circumferential edge of the die-cast housing at one end thereof towards the terminal housing, the axial groove adapted to receive the second tab.

19. The electrical connector according to claim 17, wherein the electrical connector further comprises at least one high-voltage interlocking terminal arranged to extend through a channel which is embedded in the second tab and a portion of a circumferential edge of the terminal housing is axially aligned with the second tab.

20. The electrical connector according to claim 19, wherein the electrical connector further comprises at least one third seal, each third seal being sleeved over a respective one high-voltage interlocking terminal and being pressed against and sealed between an outer surface of the respective one high-voltage interlocking terminal and an inner surface of the channel.

21. The electrical connector according to claim 19, wherein the second tab extends axially away from the terminal, by a length shorter than that of the first tab.

22. The electrical connector according to claim 14, wherein the terminal housing further includes a boss arranged between an end of the terminal housing facing away from the die-cast housing and the second circumferential groove, and extends radially outwards, and the boss is axially aligned with the first tab.

23. An electrical connector assembly, wherein the electrical connector assembly comprises at least two electrical connectors each according to claim 1, respective die-cast housings of the at least two electrical connectors being collectively integrally formed.

24. An electrical connector, comprising:
a conductive terminal;
an insulated terminal housing at least partially accommodating the terminal;
an outer housing at least partially accommodating the terminal housing;
a first sealing component sleeved onto the terminal, the terminal adapted to be axially inserted into the terminal housing in response to the first sealing component being sleeved onto the terminal, with the first sealing component being pressed against and sealed between the terminal and the terminal housing; and
a second sealing component sleeved onto the terminal housing, the terminal housing adapted to be inserted into the outer housing in response to the second sealing member being sleeved onto the terminal housing, with the second sealing component being pressed against and sealed between the terminal housing and the outer housing.
